(19) United States
(12) Patent Application Publication
(10) Pub. No.: US 2022/0083915 A1
(43) Pub. Date: Mar. 17, 2022

(54) DISCRIMINATIVE MACHINE LEARNING SYSTEM FOR OPTIMIZATION OF MULTIPLE OBJECTIVES

(71) Applicant: Feedzai - Consultadoria e Inovação Tecnológica, S.A., Coimbra (PT)

(72) Inventors: Carolina Almeida Duarte, Lisbon (PT); João Guilherme Simões Bravo Ferreira, Lisbon (PT); Pedro Caldeira Abreu, London (GB); João Pedro Valdeira Caetano, Lisbon (PT); Telmo Luís Eleutério Marquês, Lisbon (PT); João Tiago Barriga Negra Ascensão, Lisbon (PT); Jaime Rodrigues Ferreira, Lisbon (PT); Pedro Gustavo Santos Rodrigues Bizarro, Lisbon (PT)

(21) Appl. No.: 17/473,153

(22) Filed: Sep. 13, 2021

Related U.S. Application Data
(60) Provisional application No. 63/079,347, filed on Sep. 16, 2020.

(30) Foreign Application Priority Data
Sep. 10, 2021 (EP) 21195931.7
Sep. 10, 2021 (PT) 117450

(51) Int. Cl. G06N 20/00; G06K 9/62

(52) U.S. Cl. CPC G06N 20/00; G06K 9/6277; G06K 9/6256; G06K 9/623

(57) ABSTRACT

Input data is received. The received input data is provided to a trained discriminative machine learning model to determine an inference result. At least a portion of the received input data is used to determine a utility measure. A version of the determined inference result and the utility measure are used as inputs to a decision module optimizing one or more decision metrics to determine a decision result.

### CROSS REFERENCE TO OTHER APPLICATIONS

This application claims priority to U.S. Provisional Patent Application No. 63/079,347 entitled POST-PROCESSING SYSTEM FOR DECISION OPTIMIZATION FOR FRAUD DETECTION WITH DISCRIMINATIVE MODELS filed Sep. 16, 2020, which is incorporated herein by reference for all purposes.

This application claims priority to Portugal Provisional Patent Application No. 117450 entitled DISCRIMINATIVE MACHINE LEARNING SYSTEM FOR OPTIMIZATION OF MULTIPLE OBJECTIVES filed Sep. 10, 2021, which is incorporated herein by reference for all purposes.

This application claims priority to European Patent Application No. 21195931.7 entitled DISCRIMINATIVE MACHINE LEARNING SYSTEM FOR OPTIMIZATION OF MULTIPLE OBJECTIVES filed Sep. 10, 2021, which is incorporated herein by reference for all purposes.

### BACKGROUND OF THE INVENTION

Machine learning (ML) involves the use of algorithms and models built based on sample data, known as training data, in order to make predictions or decisions without being explicitly programmed to do so. ML has been increasingly used for automated decision-making, allowing for better and faster decisions in a wide range of areas, such as financial services and healthcare. However, it can be challenging to develop machine learning models for a wide variety of decision objectives for any particular domain. Thus, it would be beneficial to develop techniques directed toward efficiently and flexibly handling various decision objectives of interest for a particular domain.

### BRIEF DESCRIPTION OF THE DRAWINGS

Various embodiments of the invention are disclosed in the following detailed description and the accompanying drawings.

FIG. 1 is a block diagram illustrating an embodiment of a discriminative system for making decisions.

FIG. 2 is a block diagram illustrating an embodiment of a system for making optimized decisions for a variety of metrics.

FIG. 3 is a block diagram illustrating an alternative embodiment of a system for making optimized decisions for a variety of metrics.

FIG. 4 is a flow diagram illustrating an embodiment of a process for making an optimized decision associated with a particular decision metric.

FIG. 5 is a functional diagram illustrating a programmed computer system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A machine learning system is disclosed. Input data is received. The received input data is provided to a trained discriminative machine learning model to determine an inference result. At least a portion of the received input data is used to determine a utility measure. A version of the determined inference result and the utility measure are used as inputs to a decision module optimizing one or more decision metrics to determine a decision result.

As used herein, a discriminative machine learning model refers to a machine learning model that can be used for classification. Stated alternatively, discriminative models assign to each input (or point in an input space) an estimate of the probability that it belongs to each possible class, and this mapping is learned from observed data. Fraud detection (e.g., determining whether a transaction is fraudulent or not) is described in detail as an example domain for the techniques disclosed herein. The fraud detection example is illustrative and not restrictive. For example, the techniques disclosed herein can also be applied to determining money laundering, account takeover, inappropriate account opening, other non-legitimate account activity behavior, and so forth. The techniques disclosed herein are also applicable to other fields (e.g., medical diagnosis, image recognition, or any other machine learning application domain). Furthermore, classification outcomes need not be binary. For example, a fraud detection outcome for a transaction may be selected from among three options: accept the transaction as legitimate, decline the transaction as fraudulent, or mark the transaction for further review. The terms discriminative model, machine learning model, or model may also be used herein to refer to a discriminative machine learning model. As used herein, with respect to optimization, it should be appreciated that any analysis framed in terms of utility may also be framed in terms of cost (e.g., cost can be defined as negative utility). For example, maximization of a particular utility metric may also be described as minimization of a corresponding cost metric. Thus, it should be appreciated that a description with respect to a particular utility metric also contemplates, describes, and discloses a corresponding description with respect to a corresponding cost metric.

In various embodiments, a system is tasked with producing an action for each incoming data instance. When configured for fraud detection, the system may be tasked with producing an action (e.g., accept, decline, or review) for each incoming transaction. This problem can be framed as finding a decision rule, α(x), mapping a vector of inputs (the features), x∈X, to an action, \hat{α}∈A. In many scenarios, it is possible to focus on binary classification with two possible actions: predict 0 (negative class, e.g., legitimate) or predict 1 (positive class, e.g., fraudulent), henceforth abbreviated as A={0, 1}.

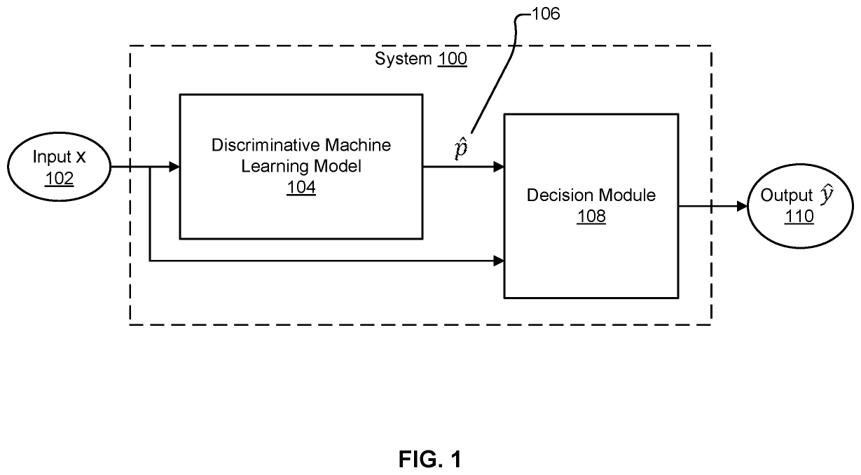

In various embodiments, an approach to producing a decision rule is to train a machine learning model that either outputs a decision directly, or that outputs a prediction which can be used to produce a decision based on a selected threshold. Stated alternatively, a machine learning system can be configured by: (1) training a model to output an optimized decision directly or (2) using a decision module after the model. FIG. 1 illustrates the latter approach. In some embodiments, discriminative models, which attempt to fit class posterior probabilities, p(y|x), directly, are employed. The problem of making an optimal decision can then be handled in a separate step. Thus, classification can be separated into an inference stage of a machine learning model that outputs probabilities based on inputs to the machine learning model and a decision stage that determines an action based on a suitable decision function acting on the outputted probabilities from the machine learning model and the inputs to the machine learning model.

Benefits of this approach include: 1) providing estimates of class posterior probabilities, which can be useful regardless of the final decision (e.g., to present to a human analyst as it provides more insight into the process that produced the decision), 2) allowing changes in a metric of interest without needing to retrain the machine learning model, e.g., by adjusting the decision function, and 3) allowing for changes in class priors (e.g., differences in distributions of positive and negative examples, such as fraud versus no fraud) to be corrected if known by modifying probabilities estimated by the machine learning model directly.

FIG. 1 is a block diagram illustrating an embodiment of a discriminative system for making decisions. In the example illustrated, system 100 receives input x 102 and generates output ŷ 110. System 100 includes discriminative machine learning model 104 and decision module 108. In the example shown, the intermediate output transmitted from discriminative machine learning model 104 to decision module 108 is \hat{p} 106. A detailed description of this two-stage approach is as follows.

In various embodiments, input x 102 comprises a vector of inputs. For example, with respect to the example of fraud detection, input x 102 may include various features of a transaction, such as numerical values corresponding to: purchase amount for the transaction, total purchase amounts for other transactions by a same purchaser in a specified period of time, time between recent purchases, etc. Non-numerical features may also be included in input x 102. Non-numerical features may be converted to numerical values and included in input x 102. For example, whether a billing address associated with the transaction matches a known billing address on file can be represented as 0 for no and 1 for yes. It is also possible for input x 102 to include non-numerical values, such as the billing address.

Discriminative machine learning model 104 utilizes input x 102 to determine an inference result. The inference result may be a class posterior probability estimate. This is illustrated in system 100 as probability estimate \hat{p} 106. With respect to the example of fraud detection, \hat{p} 106 may be a probability estimate of a transaction corresponding to input x 102 being fraudulent. In the case of binary classification, only one probability estimate is required because the probability for the other outcome (e.g., legitimate) can be readily determined to be one minus the probability estimate output of discriminative machine learning model 104. Several probability estimates may be outputted in non-binary classification applications. Examples of discriminative machine learning model 104 include gradient boosted decision trees, random forests, bagged decision trees, and neural networks.

With respect to discriminative machine learning model 104, training loss is usually a measure of calibration of the class posterior probability estimates (e.g., log-loss) and not necessarily a good surrogate for a specified metric of interest for optimization. Stated alternatively, discriminative machine learning model 104 learns to estimate class posterior probabilities (e.g., a probability of a positive class given input features). With respect to fraud detection, in various embodiments, the positive class corresponds to the case of a transaction being or likely being fraudulent. In many scenarios, this discriminative model output by itself is not sufficient to make an optimal decision. For example, two samples with the same probability of belonging to the positive class (same discriminative model output) may not necessarily result in the same cost. Consider the following scenario in which an issuer (e.g., a financial institution) is liable for fraud losses. Approving a fraud transaction would result in a full loss of the transaction value (as the financial institution would need to reimburse a client of the financial institution). On the other hand, declining a legitimate (non-fraud) transaction causes customer friction, but has no immediate financial impact up to a level (e.g., losing the client). Under this scenario, it may be desirable to maximize the amount (e.g., in terms of money) of fraud that is stopped, while reducing the number of false positives (associated with client friction from incorrectly declining legitimate transactions). Thus, a main goal of a decision stage may be to derive a decision rule that achieves a best generalization performance as measured by some metric of interest, in other words, to achieve a smallest expected loss (or a highest expected utility) with respect to a true distribution of inputs.

In various embodiments, decision module 108 uses at least a portion of the received input x 102 to determine a utility measure (or a cost measure). As used herein, utility measure is also referred to as utility metric, and cost measure is also referred to as cost metric. In various embodiments, decision module 108 uses a version of a determined inference result of the discriminative machine learning model 104 (e.g., a version of \hat{p} 106) and the utility measure to optimize for and determine a decision result (e.g., output ŷ 110). With respect to the example of fraud detection, in some embodiments, output ŷ 110 is a decision for which the two options are to approve the transaction corresponding to input x 102 or decline the transaction corresponding to input x 102. In contrast to a decision based on just \hat{p} 106, output ŷ 110 also depends on the utility measure. Output ŷ 110 is able to take into account expected loss with respect to a true distribution of inputs: R(α)=∫R(α(x)|x)p(x)dx (Equation 1). In Equation 1, p(x) denotes the probability distribution of the inputs and R(α(x)|x) is the conditional risk, i.e., an expected loss under the true class posterior distribution at x:

$$R ( \hat{y} \vert x ) = {\sum }_{y ∈ 𝒴} l ( \hat{y} , y ; x ) p ( y \vert x ) . \qquad ( Equation 2 )$$

Here l(ŷ, y; x) denotes the cost associated with classifying an example (x, y) as being of class ŷ. In the fraud detection domain, in various embodiments, a trade-off between two metrics is of interest. For example, the trade-off may be between the two types of errors in a binary classification task: false negatives (fraudulent transactions classified as legitimate) and false positives (legitimate transactions classified as fraudulent). The former leads to financial losses and the latter to incorrectly blocked transactions that, in turn, can undermine otherwise valid transactions and, ultimately, customer satisfaction. In various embodiments, the rate of one type of error is minimized while controlling for the other, e.g.:

$$arg {min}_{α} {R}_{0} ( α ) s . t . {R}_{1} ( α ) \leq {r}_{1} . \qquad ( Equation 3 )$$

In some embodiments, a type of recall (e.g., transaction recall or money recall) is maximized. This is equivalent to minimizing the false negative rate (FNR) while constraining a variant of the false positive rate (FPR). In some scenarios, the constraint is not directly based on FPR, but on a combination of both types of errors (e.g., an alert rate or precision constraint).

As described in further detail herein, the following are disclosed: 1) decision functions for a subclass of problems such as those in Equation 3 that correspond to specified metrics, 2) a post-processing systems for implementing these decision functions from the predictions of a discriminative model, 3) extensions of these systems to multi-objective scenarios, e.g., by introducing a parameterized scoring function, e.g., the Amount Dependent Score Update (ADSU), that combines transaction and money recall, and 4) techniques to handle poorly calibrated models or models whose output cannot necessarily be interpreted as class probabilities.

The overall risk of Equation 1 is minimized if for every x, the action α(x) that minimizes the conditional risk of Equation 2 is chosen. For binary classification, this is given by: R(ŷ=k|x)=l(k, 0; x)p(y=0|x)+l(k, 1; x)p(y=1|x) (Equation 4) (with k being any of the possible values of ŷ). With respect to fraud detection, the costs, l(k, j; x), can depend on an amount feature, for example. Costs can be expressed as elements of a cost matrix Lₖⱼ=l(k, j). For the binary classification case, cost elements L₀₁ and L₁₀ would denote costs associated with a false negative and a false positive, respectively. If these costs are modeled explicitly, the optimal decision function comprises choosing α(x)=1 if the conditional risk of predicting the positive class is smaller than the conditional risk of predicting the negative one:

$$α ( x ) = \{ \begin{matrix}1 & if R ( 1 \vert x ) < R ( 0 \vert x ) \\ 0 & otherwise\end{matrix} . \qquad ( Equation 5 )$$

One approach to make a classifier cost-sensitive is through introducing class weights directly in a loss function l as follows:

$${min}_{θ} \frac{1}{\vert D \vert} {\sum }_{( x , y ) ∈ D} {w}_{y} l ( \hat{η} ( x ; θ ) , y ) . \qquad ( Equation 6 )$$

An indirect way to achieve the same result is by modifying the base rates of the training dataset, either through subsampling or oversampling one or both classes. In effect, using stratified sampling to create a training set with base rates \tilde{π}ₖ is equivalent to weighting each class in the loss function by the factor ωₖ=\tilde{π}ₖ/πₖ where πₖ are the base rates of the original dataset. For a fixed costs binary classification problem, the decision boundary can be of the form:

$$η ( x ) = \frac{{L}_{10} - {L}_{00}}{{L}_{10} - {L}_{00} + {L}_{01} - {L}_{11}} \text{=:} c , \qquad ( Equation 7 )$$

which can be achieved using a classifier that makes a decision based on a threshold of ½ by setting class weights such that

$$\frac{{ω}_{0}}{{ω}_{1} + {ω}_{0}} = C .$$

The two-stage approach to binary classification of system 100 relies on good estimates of the class posterior probabilities, p(y|x), by discriminative machine learning model 104. Some types of machine learning models may return poorly calibrated probabilities. In some embodiments, as described in further detail herein, a probability calibration technique is utilized to transform model scores in order to cope with poorly calibrated estimates. An example of a probability calibration technique is Platt scaling, which models the posterior probabilities as a sigmoid of an affine function of the model scores \hat{η}: p(y|x)≈σ(a\hat{η}(x; θ)+b). The added “model” parameters (a and b) can be fitted through maximum likelihood on the calibration set (while holding θ fixed). Another example of a probability calibration technique is isotonic regression, which fits a more flexible isotonic (monotonically increasing) transformation of model scores. In various embodiments, an independent out-of-sample set for calibrating the probabilities is utilized in order to avoid over-fitting.

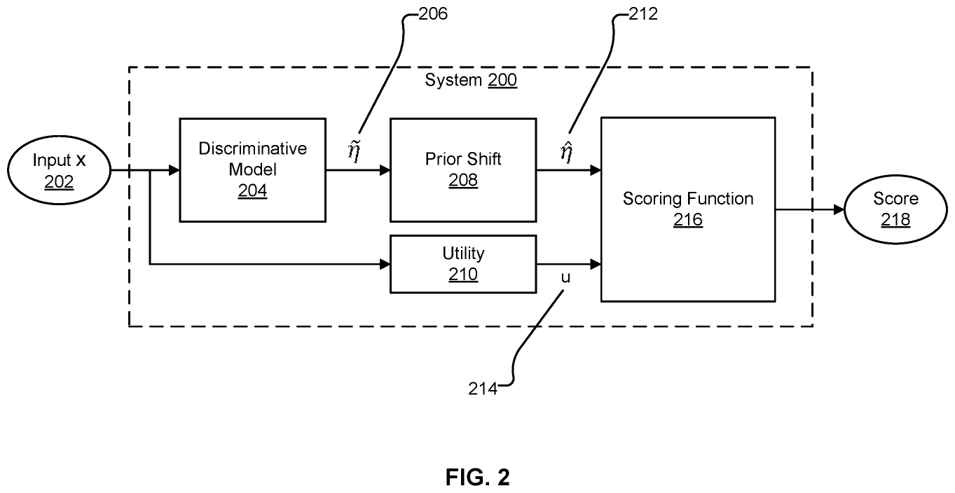

FIG. 2 is a block diagram illustrating an embodiment of a system for making optimized decisions for a variety of metrics. In the example illustrated, system 200 receives input x 202 and generates score 218. System 200 includes discriminative model 204, prior shift 208, utility 210, and scoring function 216. In the example shown, intermediate outputs within system 200 are \tilde{η} 206, \hat{η} 212, and u 214. In some embodiments, input x 202 is input x 102 of FIG. 1. In some embodiments, discriminative model 204 is discriminative machine learning model 104 of FIG. 1. In some embodiments, \tilde{η} 206 is \hat{p} 106 of FIG. 1. In some embodiments, prior shift 208, utility 210, and scoring function 216 are included in decision module 108 of FIG. 1. In some embodiments, score 218 is thresholded and/or otherwise processed to arrive at output ŷ 110 of FIG. 1. System 200 is described in further detail below.

In various embodiments, a primary purpose of system 200 is to make use of the probabilistic predictions of discriminative model 204 in order to produce a decision (e.g., reject or accept), so as to maximize a specified metric of interest. In various scenarios, these metrics correspond to maximizing some measure of utility such as recall or money recall, while keeping some measure of cost fixed (e.g., alert rate or false positive rate). In various embodiments, with respect to the example of fraud detection, score 218 indicates a utility-to-cost ratio that can be compared with a threshold value to arrive at a final decision. The following example, a fraud detection example, illustrates an important advantage of system 200. Suppose two transactions, one with a very small money amount and one with a large money amount, would be determined by discriminative model 204 to be equally likely to be fraudulent. However, a wrong decision on the transaction with the large money amount can be considerably more costly. Thus, in order to minimize costs, it is crucial to optimize for utility-to-cost ratio rather than mere probability of fraud. System 200 makes such decisions optimized for a variety of metrics. In the example illustrated, discriminative model 204 generates class probability estimates for input data instances (e.g., transactions). Prior shift 208 corrects the probability estimates of discriminative model 204 assuming a known mismatch between base rates in training and production data. Production data refers to non-training data received after a model is deployed (post-training) in inference mode. Scoring function 216 assigns a score for each input data instance (e.g., each transaction) based on the estimated class probability and a utility in order to generate an optimal decision according to a metric of interest.

In various embodiments, discriminative model 204 produces probabilistic predictions for each class given a feature vector: \tilde{η}(x)≈η(x). Stated alternatively, discriminative model 204 is expected to be trained by minimizing a proper scoring rule (e.g., a neural network trained for binary cross-entropy) and generate accurate forecasts \tilde{η} 206. However, this may not be the case, for example, if discriminative model 204 overfits training data. It is possible to employ probability calibration methods such as Platt scaling and isotonic regression (e.g., see above), which can be regarded as fitting an additional parametric or non-parametric isotonic function to the discriminative model 204's outputs by minimizing a given proper scoring rule (log-loss and Brier score, respectively) on a hold-out dataset. It is also possible to employ a different approach in which miscalibration is handled by parameterizing directly a flexible scoring function, as described in further detail below.

In the example illustrated, prior shift 208 receives probabilistic predictions \tilde{η} 206 as an input and generates a corrected version \hat{η} 212. When the class priors on the dataset in which discriminative model 204 was trained do not match the priors that would be encountered in a production setting, the class probabilities estimated by discriminative model 204 benefit from correction. Two common sources of such a mismatch are when applying undersampling/oversampling of one of the classes or when class weights are used while training discriminative model 204.

Undersampling/oversampling of one of the classes can occur when performing stratified sampling (e.g., undersampling the majority class) when dealing with large and unbalanced datasets. For example, with respect to fraud detection, non-fraudulent examples (no fraud being the majority class) are oftentimes undersampled. Thus, in some embodiments, prior shift 208 corrects for a fraud rate in the training dataset being higher than during model deployment. Undersampling/oversampling changes the class priors, p(y), in the training dataset but not the class conditional probabilities p(x|y=k). Hence, the following class conditional ratios for the original and training datasets, denoted as \tilde{p}(x|y=k), also remain equal:

$$\frac{\tilde{p} ( x \vert y = 1 )}{\tilde{p} ( x \vert y = 0 )} = \frac{p ( x \vert y = 1 )}{p ( x \vert y = 0 )} . \qquad ( Equation 8 )$$

Using Bayes' theorem, the following relation between the class posterior probabilities can be derived:

$$\frac{\tilde{p} ( y = 1 \vert x )}{\tilde{p} ( y = 0 \vert x )} \frac{\tilde{p} ( y = 0 )}{\tilde{p} ( y = 1 )} = \frac{p ( y = 1 \vert x )}{p ( y = 0 \vert x )} \frac{p ( y = 0 )}{p ( y = 1 )} . \qquad ( Equation 9 )$$

Here, \tilde{p} is used to denote probabilities in the training dataset. If a number c∈[0, 1] is defined such that:

$$\frac{c}{1 - c} := \frac{\tilde{p} ( y = 0 )}{\tilde{p} ( y = 1 )} \frac{p ( y = 1 )}{p ( y = 0 )} ⇔ c := \frac{\tilde{p} ( y = 0 ) p ( y = 1 )}{\tilde{p} ( y = 0 ) p ( y = 1 ) + \tilde{p} ( y = 1 ) p ( y = 0 )} , \qquad ( Equation 10 )$$

then solving Equation 9 for η=p(y=1|x) as a function of \tilde{η}=\tilde{p}(y=1|x) (omitting the dependence on x for brevity) yields:

$$η = \frac{\tilde{η} c}{\tilde{η} c + ( 1 - \tilde{η} ) ( 1 - c )} = : {q}_{c} ( \tilde{η} ) . \qquad ( Equation 11 )$$

The defined function q_{c} maps the class conditional probabilities on a c-weighted dataset (what the discriminative classifier will learn) to the corresponding class conditional probabilities on the original dataset. For c∈[0, 1], this function is strictly monotonic and thus invertible, satisfying:

q_{c}⁻¹(η)=q_{1-c}(η) (Equation 12).

A similar problem arises when introducing class weights in the loss function used to train discriminative model 204. Denoting \tilde{π}_{y} the base rates in the training dataset and further introducing weights ω₁ and ω₀ on the positive and negative examples in the loss function, the priors in the training set are now effectively:

$$\tilde{p} ( y = k ) = \frac{{w}_{k} {\tilde{}}_{k}}{{w}_{0} {\tilde{}}_{0} + {w}_{1} {\tilde{}}_{1}} , k ∈ \{ 0 , 1 \} . \qquad ( Equation 13 )$$

The prior shift parameter, c, thus becomes:

$$\frac{c}{1 - c} = \frac{{w}_{0} {\tilde{}}_{0} {}_{1}}{{w}_{1} {\tilde{}}_{1} {}_{0}} ⇔ c = \frac{{w}_{0} {\tilde{}}_{0} {}_{1}}{{w}_{0} {\tilde{}}_{0} {}_{1} + {w}_{1} {\tilde{}}_{1} {}_{0}} , \qquad ( Equation 14 )$$

where πₖ=p(y=k) denotes the base rates in the original dataset.

In various embodiments, prior shift 208 corrects any prior shift that might have been introduced by stratified sampling by target class, or class weights used while training discriminative model 204, or both. While sampling ratios are often selected based on practical considerations (e.g., the training set size), class weights can be used as a hyperparameter to determine a proper balance between positive and negative examples to improve performance. Furthermore, prior shift correction is also useful in a scenario where priors are expected to change in a production setting relative to the priors present in the training data.

In the example illustrated, scoring function 216 takes inputs \hat{η} 212 from prior shift 208 and u 214 from utility 210. In various embodiments, \hat{η} 212 is a modified version (prior shift corrected) of an inference result generated by discriminative model 204. In various embodiments, u 214 is a utility measure determined by utility 210 based on at least a portion of input x 202. In some embodiments, the utility measure is associated with a type of recall (e.g., transaction recall, money recall, etc.). In various embodiments, scoring function 216 attempts to maximize recall (equivalent to minimizing false negative rate). Maximizing recall corresponds to maximizing detection of true positives. For example, with respect to fraud detection, maximizing transaction recall corresponds to maximizing labeling of fraudulent transactions as fraudulent. In various embodiments, recall is maximized (true positives maximized) subject to keeping the false positive rate below a specified threshold:

$${max}_{α} T P R ( α ) = {\int }_{\{ x \vert α ( x ) = 1 \}} p ( x \vert y = 1 ) dx \\ s . t . F P R ( α ) = {\int }_{\{ x \vert α ( x ) = 1 \}} p ( x \vert y = 0 ) dx \leq b . \qquad ( Equation 15 )$$

The criterion of Equation 15 can be referred to as a Neyman-Pearson criterion and is similar to statistical hypothesis testing in which power is maximized subject to a constraint on probability type I errors. Here, a goal is to determine a set of points to include in a “rejection region,” which in a fraud detection setting corresponds to the region where a transaction is marked as fraudulent, R₁={x|α(x)=1}, to capture as many positive examples subject to a constraint on the number of negative examples. If the feature space is discrete, this becomes a 0-1 knapsack problem in which p(x|y=1) are the values for each point and p(x|y=0) are the weights of the knapsack constraint.

In some embodiments, the discrete knapsack problem is converted into a continuous knapsack problem by probabilistic relaxation. The search space is extended to that of randomized decision rules, by allowing the decision function to return a probability distribution over the action space (the set of all possible actions), instead of a single deterministic action. For the binary classification problem, this means that α(x)∈[0, 1] can now be interpreted as a probability of deciding ŷ=1. With respect to the examples described herein in the context of fraud detection, deciding ŷ=1 corresponds to deciding that a transaction is fraudulent. The relaxed problem is then solved by selecting the points in order of their value-to-weight ratio until the capacity b is reached. Stated alternatively, points are ordered according to the following likelihood ratio:

$$r ( x ) = \frac{p ( x \vert y = 1 )}{p ( x \vert y = 0 )} . \qquad ( Equation 16 )$$

If adding a point in the input space to the decision region in this fashion causes capacity b to be exceeded, then only a fraction α(x)<1 of that point is included in the rejection region (i.e., a randomized decision is made for this point). In the discrete case, these random decisions would only take place for one point in feature space (unless multiple points happen to have the same likelihood ratio), and in a continuous feature space only on the boundary of the decision region, thus having little effect in practice. These can be ignored, and the decision function can be described simply as:

$$α ( x ) = \{ \begin{matrix}1 & if r ( x ) \geq {k}_{b} \\ 0 & otherwise\end{matrix} , \qquad ( Equation 17 )$$

where the threshold k_{b} is chosen as small as possible to reject as much as possible to maximize true positive rate (TPR) while keeping the constraint satisfied, i.e., while keeping the FPR below the specified value: ∫_{{x|r(x)≥k}_{_{b}}_{}} p(x|y=0)dx≤b (Equation 18). In various embodiments, generative models are not relied upon, and thus the class conditional probabilities in Equation 16 are not able to be estimated. Their ratio, however, is proportional to the odds-ratio:

$$r ( x ) = \frac{p ( y = 1 \vert x )}{p ( y = 0 \vert x )} \frac{p ( y = 0 )}{p ( y = 1 )} = \frac{η ( x )}{1 - η ( x )} \frac{{}_{0}}{{}_{1}} , \qquad ( Equation 19 )$$

allowing for the condition for predicting ŷ=1 to be expressed as:

$$\frac{η ( x )}{1 - η ( x )} \geq {k}_{b} \frac{{}_{1}}{{}_{0}} ⇔ η ( x ) \geq \frac{{k}_{b} {}_{1}}{{k}_{b} {}_{1} + {}_{0}} . \qquad ( Equation 20 )$$

The decision rule of Equation 20 corresponds to applying a threshold on the class posterior probability and is therefore similar to the decision rule for a cost-sensitive problem with fixed costs in Equation 7. Unlike the fixed costs problem, in which the threshold depends only on the cost matrix elements, here the threshold has to be determined by taking into account the distribution p(x|y=0) (Equation 18). In some embodiments, it is estimated using a finite sample from it (e.g., a sample of negative examples from a validation set to avoid introducing additional bias). An estimate of η(x) for all examples is not strictly necessary, only a strictly monotonic transformation of it because the sub-level sets would be the same.

In some embodiments, a metric other than transaction recall is maximized. For example, in some embodiments, money recall is maximized. With respect to fraud detection, transaction recall and money recall are different in that money recall is associated with expected monetary loss from fraud. Thus, maximizing money recall maximizes prevention of monetary loss as opposed to merely maximizing TPR (TPR corresponding to detecting fraud when actual fraud exists). For money recall, higher money value transactions are emphasized (e.g., TPR may decrease because small money value false negatives do not impact the money recall utility measure as significantly). In general, if a true positive example carries a utility u(x), which is a function of input x 202, the expected utility as a function of the decision rule is given by: U(α)=∫_{{x|α(x)=1}} u(x)p(x|y=1)dx (Equation 21) and the condition for predicting ŷ=1 becomes:

$$u ( x ) \frac{η ( x )}{1 - η ( x )} \geq {k}_{b} \frac{{}_{1}}{{}_{0}} ⇔ η ( x ) \geq \frac{{k}_{b} {}_{1}}{{k}_{b} {}_{1} + u ( x ) {}_{0}} . \qquad ( Equation 22 )$$

Various constraints other than FPR may be utilized. For example, alert rate may be utilized. Stated alternatively, alert rate may be utilized instead of FPR in Equation 15. In various embodiments, alert rate corresponds to alerts that include both true positive alerts and false positive alerts: AlertRate(α)=∫_{{x|α(x)=1}} p(x)dx≤b (Equation 23). The decision region for ŷ=1 then becomes u(x)η(x)≥k_{b}π₁ (Equation 24).

It is also possible for scoring function 216 to apply a precision constraint. Precision constrains can be expressed in terms of true positives (TP), false positives (FP), TPR, and FPR as:

$$Precision = \frac{T P}{T P + F P} = \frac{{}_{1} T P R}{{}_{1} T P R + {}_{0} F P R} \geq b . \qquad ( Equation 25 )$$

This is equivalent to: bπ₀FPR−(1−b)π₁TPR≤0 (Equation 26), which leads to a weight for a point x of: bp(x, y=0)−(1−b)p(x, y=1) (Equation 27). Precision constraints can lead to negative weights whenever:

$$\frac{p ( x , y = 1 )}{p ( x , y = 0 )} = \frac{η ( x )}{1 - η ( x )} > \frac{b}{1 - b} ⇔ η ( x ) > b . \qquad ( Equation 28 )$$

This means that if a point x has a probability η(x)>b of being 1 (a positive example), including it in the decision region where ŷ=1 is predicted will only increase the precision above the desired threshold, hence providing additional slack. The optimal decision rule is therefore to include all such points in R₁ first and then apply the same procedure of including all points with highest value-to-weight ratio up until the constraint is no longer satisfied:

$$u ( x ) \frac{η ( x )}{b - η ( x )} \geq {k}_{b} {}_{1} . \qquad ( Equation 29 )$$

Unlike other decision rules, which depend only on the constraint value b through the constant k_{b}, this decision rule explicitly depends on b. As such, changing b implies possibly changing the ordering of examples and not just the threshold determining which examples fall into which region.

Decision regions for various types of constraints as a function of the utility u(x) of a true positive example and the class posterior probability η(x):=p(y=1|x) are given in tabular format below. These represent theoretical ideal decision regions expressed as a function of the true class probability estimate η(x).

TABLE 1

| Constraint | [symbol] ₁ |
|---|---|
| FPR ≤ b | $u ( x ) \frac{η ( x )}{1 - η ( x )} \geq {k}_{b} \frac{{π}_{1}}{{π}_{0}}$ |
| Alert Rate ≤ b | u(x)η(x) ≥ k_{b}π₁ |
| Precision ≥ b | $η ( x ) \geq b ⋁ u ( x ) \frac{η ( x )}{b - η ( x )} \geq {k}_{b} {π}_{1}$ |

As described above, optimal decision regions for maximizing a utility weighted recall, subject to different constraints, have been derived. These can be implemented as a threshold on some function of the class-posterior probabilities η(x) and a utility u(x), as expressed in Table 1. These functions produce a score reflecting the expected utility-to-cost ratio of rejecting a data example (e.g., a given transaction). In various embodiments, discriminative model 204 estimates the class posterior probabilities (possibly after correcting for a prior shift of the training dataset). In various embodiments, the utilities for each example (e.g., transaction to be accepted or rejected) are known. In the example illustrated, utility 210 generates a utility u(x) for each input x 202. As shown in Table 1, utility u(x) is multiplied with probability η(x). The utility is based on a specified metric. Metrics can be any function of input x 202. For example, with respect to money recall, a metric based on transaction purchase amount information of input x 202 can be formulated. Stated alternatively, u(x) may be a money amount or a variant thereof.

The constants k_{b} in the decision rules of Table 1 should be determined so as to satisfy the respective constraints. Without access to the true data probabilities, p(x), or class conditional probabilities, p(x|y), they need to be estimated based on empirical distributions. This can be accomplished by choosing the lowest value for the threshold on the scores that still satisfies the constraints. This can be done in a validation dataset to avoid a biased estimate.

In the example illustrated, scoring function 216 takes as input the estimated class probability \hat{η} 212 and utility u 214 corresponding to input x 202 and outputs the estimated score 218. Because utility-to-cost ratios can often be arbitrarily high (s(\hat{η}, u)∈R+ even if u is non-negative and bounded) and it is often desirable to have a score in a predefined interval (e.g., [0, 1]), the scoring function can be formed with any strictly monotonically increasing function over the score domain such as

$$s \to \frac{s}{s + 1} \qquad ( Equation 30 )$$

when the original scores are non-negative. Table 2 below lists scoring functions for utility-weighted recall subject to different constraints, both before and after use of Equation 30. The functions in Table 2 are expressed in terms of utility u of a true positive example and the estimated positive class posterior probability \hat{η} (as opposed to true class probabilities η in Table 1). The scoring functions in Table 2 approximate the ideal decision boundaries in Table 1 by replacing the true class probabilities η, which are not known, with estimates \hat{η} by the discriminative model, which are known.

TABLE 2

| Constraint | s(\hat{η}, u) | s(\hat{η}, u) normalized |
|---|---|---|
| FPR ≤ b | $u \frac{\hat{η}}{1 - \hat{η}}$ | $\frac{u \hat{η}}{1 + ( u - 1 ) \hat{η}}$ |
| Alert Rate ≤ b | u\hat{η} | $\frac{u \hat{η}}{1 + u \hat{η}}$ |
| Precision ≥ b | $\{ \begin{matrix}u \frac{\hat{η}}{b - \hat{η}} & if \hat{η} \leq b \\ ∞ & otherwise\end{matrix}$ | $\{ \begin{matrix}\frac{u \hat{η}}{b + ( u - 1 ) \hat{η}} & if \hat{η} \leq b \\ 1 & otherwise\end{matrix}$ |

In scenarios in which a single metric is utilized and discriminative model 204 produces well-calibrated probability estimates (possibly after prior shift correction), the appropriate scoring function for the metric of interest (such as those listed in Table 2) can be readily selected. However, there exist scenarios in which it may be desirable to trade-off more than one metric of interest. For example, in some scenarios, e.g., with respect to fraud detection, both transaction and money recall may be of interest. In some embodiments, in order to trade off multiple metrics, a parameterized scoring function (also referred to as an Amount Dependent Score Update (ADSU)) is utilized s(\hat{η}, u; k)=(1+ku)\hat{n} (Equation 31). In Equation 31, the parameter k allows for the trade-off between maximizing recall per alert and the u-weighted recall per alert. Thus, if the u-weighted recall is money recall, both transaction recall and money recall can be taken into account. For k=0, the scoring rule in Equation 31 would match the scoring rule for recall at alert rate or FPR. For k→∞, the scoring rule in Equation 31 would match u-weighted recall at alert rate. For

$$k = \frac{{π}_{0}}{{π}_{1} {k}_{F P R}} ,$$

the scoring rule in Equation 31 would match u-weighted recall at FPR. The parameter k can be selected by performing a hyperparameter optimization on a validation or hold-out dataset. Higher values of k increases the weight of the utility function u(x) on the final decision and, thus, the selection criterion for the value of k depends on the desired trade-off, making it case-dependent. In many scenarios, a primary goal and benefit of the parameterized scoring function is sacrificing a nominal degree of transaction recall to gain significant improvements in money recall.

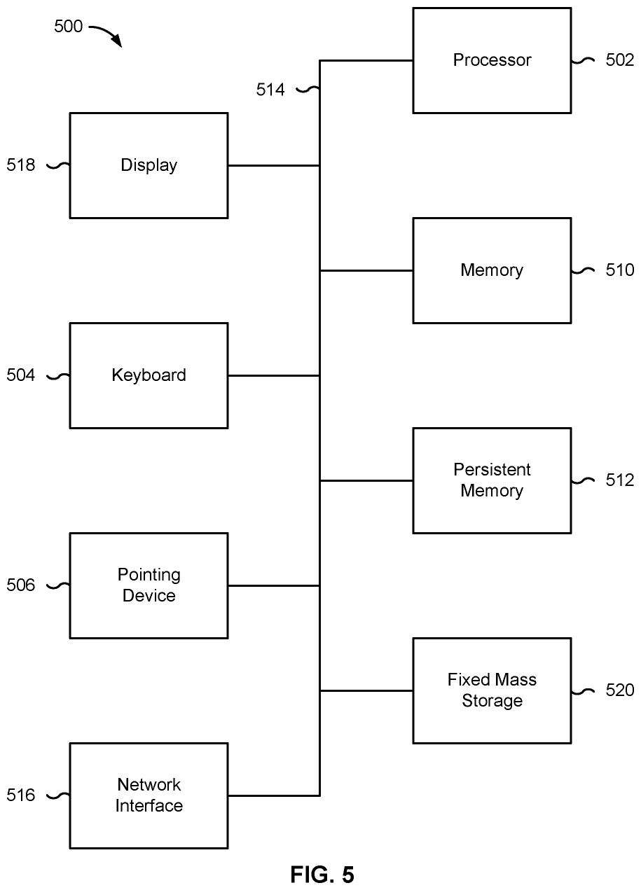

In the example shown, portions of the communication path between the components are shown. Other communication paths may exist, and the example of FIG. 2 has been simplified to illustrate the example clearly. Although single instances of components have been shown to simplify the diagram, additional instances of any of the components shown in FIG. 2 may exist. The number of components and the connections shown in FIG. 2 are merely illustrative. For example, prior shift 208, utility 210, and/or scoring function 216 may be integrated into a combined component. Components not shown in FIG. 2 may also exist. In some embodiments, at least a portion of the components of system 200 are implemented in software. In some embodiments, at least a portion of the components of system 200 are comprised of computer instructions executed on computer system 500 of FIG. 5. It is also possible for at least a portion of the components of system 200 to be implemented in hardware, e.g., in an application-specific integrated circuit (ASIC) or a field programmable gate array (FPGA).

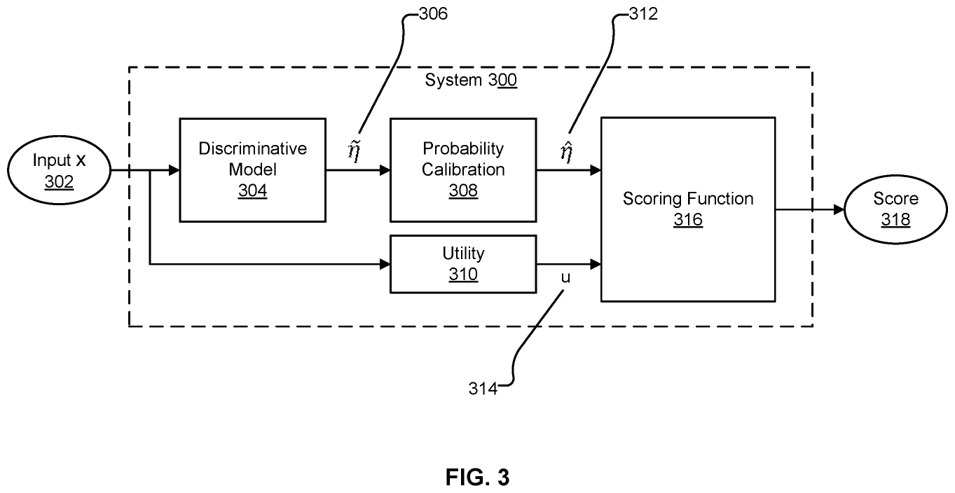

FIG. 3 is a block diagram illustrating an alternative embodiment of a system for making optimized decisions for a variety of metrics. In the example illustrated, system 300 receives input x 302 and generates score 318. System 300 includes discriminative model 304, probability calibration 308, utility 310, and scoring function 316. In the example shown, intermediate outputs within system 300 are \tilde{η} 306, \hat{η} 312, and u 314. In some embodiments, input x 202 is input x 102 of FIG. 1 and/or input x 202 of FIG. 2. In some embodiments, discriminative model 304 is discriminative machine learning model 104 of FIG. 1 and/or discriminative model 204 of FIG. 2. In some embodiments, \tilde{η} 306 is \hat{p} 106 of FIG. 1 and/or \tilde{η} 206 of FIG. 2. In some embodiments, probability calibration 308, utility 310, and scoring function 316 are included in decision module 108 of FIG. 1. In some embodiments, utility 310 is utility 210 of FIG. 2. In some embodiments u 314 is u 214 of FIG. 2. In some embodiments, score 318 is thresholded and/or otherwise processed to arrive at output ŷ 110 of FIG. 1.

System 300 differs from system 200 of FIG. 2 in that estimated probabilities of its trained discriminative machine learning model (discriminative model 304) are transmitted to a probability calibration component instead of a prior shift correction component. In scenarios in which the discriminative machine learning model does not produce well-calibrated probabilities (e.g., due to overfitting), an additional calibration step can be beneficial. In the example illustrated, probability calibration 308 performs this calibration. Various calibration techniques may be utilized, e.g., Platt scaling or isotonic regression. Such techniques fit a parameterized monotonic function to the output of discriminative model 304 in order to improve a measure of its calibration (a proper scoring rule) on a hold-out dataset. In some embodiments, calibration is performed by directly parameterizing a flexible scoring function and optimizing its parameters in order to directly maximize or minimize a metric of interest. In various embodiments, parameters of the flexible scoring function are optimized for the metric of interest on a hold-out dataset. An example of such a parameterized scoring function is a combination of the scoring function for the metric of interest with the simple monotonic function: \hat{η}→σ(α\hat{η}+b) (Equation 32), where σ can be a sigmoid function or any other strictly monotonically increasing function with range [0, 1].

In the example shown, portions of the communication path between the components are shown. Other communication paths may exist, and the example of FIG. 3 has been simplified to illustrate the example clearly. Although single instances of components have been shown to simplify the diagram, additional instances of any of the components shown in FIG. 3 may exist. The number of components and the connections shown in FIG. 3 are merely illustrative. For example, probability calibration 308, utility 310, and/or scoring function 316 may be integrated into a combined component. Components not shown in FIG. 3 may also exist. In some embodiments, at least a portion of the components of system 300 are implemented in software. In some embodiments, at least a portion of the components of system 300 are comprised of computer instructions executed on computer system 500 of FIG. 5. It is also possible for at least a portion of the components of system 300 to be implemented in hardware, e.g., in an ASIC or an FPGA.

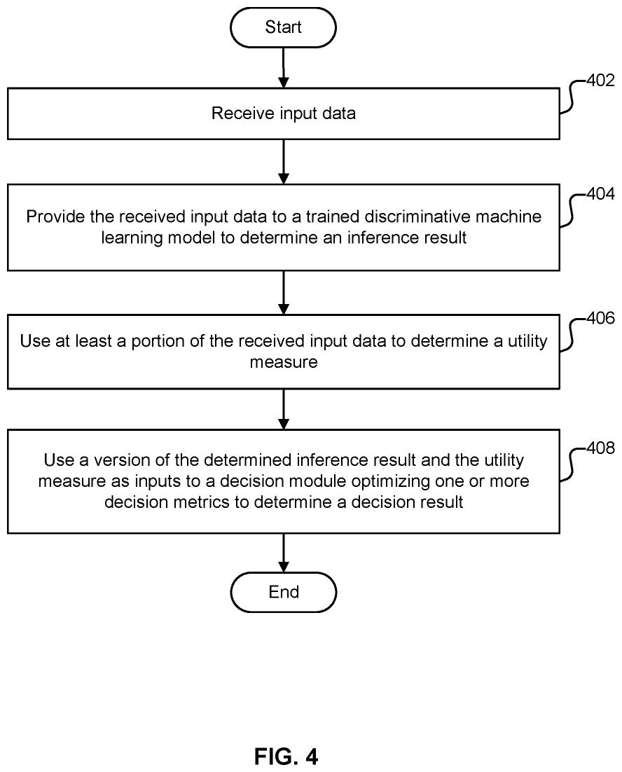

FIG. 4 is a flow diagram illustrating an embodiment of a process for making an optimized decision associated with a particular decision metric. In some embodiments, the process of FIG. 4 is performed by system 100 of FIG. 1, system 200 of FIG. 2, and/or system 300 of FIG. 3.

At 402, input data is received. In some embodiments, the input data is input x 102 of FIG. 1, input x 202 of FIG. 2, and/or input x 302 of FIG. 3. In various embodiments, the input data comprises a plurality of features and is associated with a data instance for which a classification or decision is required. With respect to the example of fraud detection, the data instance may be an individual transaction (e.g., purchase of an item) and the decision required is whether to accept or reject the transaction (accept if legitimate and reject if fraudulent). In some embodiments, the input data is a vector of numerical values. For example, with respect to fraud detection, the input data may comprise various values associated with a transaction to be determined (classified) as either fraudulent or not fraudulent (e.g., purchase amount for the transaction, total purchase amounts for other transactions by a same purchaser in a specified period of time, time between recent purchases, etc.). Non-numerical features may be converted to numerical values and included in the input data. For example, whether a billing address associated with the transaction matches a known billing address on file can be represented as 0 for no and 1 for yes. It is also possible for the input data to include non-numerical values, such as the billing address.

At 404, the received input data is provided to a trained discriminative machine learning model to determine an inference result. In some embodiments, the machine learning model is discriminative machine learning model 104 of FIG. 1, discriminative model 204 of FIG. 2, and/or discriminative model 304 of FIG. 3. Examples of machine learning models include gradient boosted decision trees, random forests, bagged decision trees, and neural networks. The machine learning model is trained utilizing training data comprised of data instances similar to the received input data in order to perform the inference task of determining the inference result for the received input data. For example, with respect to fraud detection, the machine learning model is trained using a plurality of example transactions of which some are known apriori to be legitimate (and labeled as such) and others are known apriori to be fraudulent (and labeled as such). The machine learning model learns and adapts to patterns in the training data (e.g., with respect to fraud detection, patterns associated with transaction features such as number of items purchased, shipping address, amount spent, etc.) in order to be trained to perform a decision task (e.g., determining whether a transaction is legitimate or fraudulent). In various embodiments, the machine learning model outputs the inference result in the form of a probability (e.g., with respect to fraud detection, a likelihood of a transaction being fraudulent given the input data). In some embodiments, the inference result is \hat{p} 106 of FIG. 1, \tilde{η} 206 of FIG. 2, and/or \tilde{η} 306 of FIG. 3.

At 406, at least a portion of the received input data is used to determine a utility measure. The utility measure can be any function u(x) of the received input data. For example, with respect to fraud detection, if the received input data corresponds to a transaction and includes a purchase amount of the transaction, the utility measure may be the purchase amount or a scaled or modified version thereof. Other utility measures (e.g., any function of the received input data) are also possible. In some embodiments, the utility measure is u 214 of FIG. 2 and/or u 314 of FIG. 3.

At 408, a version of the determined inference result and the utility measure are used as inputs to a decision module optimizing one or more decision metrics to determine a decision result. In some embodiments, the version of the determined inference result is the determined inference result with a prior shift correction applied (e.g., \hat{η} 212 of FIG. 2). In some embodiments, the version of the determined inference result is the determined inference result with a probability calibration applied (e.g., \hat{η} 312 of FIG. 3). In some embodiments, the decision module is decision module 108 of FIG. 1, which may include scoring function 216 of FIG. 2 and/or scoring function 316 of FIG. 3. In some embodiments, the one or more decision metrics include a constraint. For example, with respect to fraud detection, a true positive rate may be maximized subject to a false positive rate constraint (e.g., keeping the false positive rate below a specified threshold). In various embodiments, the decision result is based on a score corresponding to optimizing the one or more decision metrics. In some embodiments, the score is score 218 of FIG. 2 and/or score 318 of FIG. 3. In various embodiments, a scoring function generates the score. In various embodiments, a decision rule determines the decision result based on the score. In some embodiments, e.g., with respect to fraud detection, the decision result is whether to accept or reject a transaction.

FIG. 5 is a functional diagram illustrating a programmed computer system. In some embodiments, the process of FIG. 4 is executed by computer system 500. In some embodiments, at least a portion of system 100 of FIG. 1, system 200 of FIG. 2, and/or system 300 of FIG. 3 are implemented as computer instructions executed by computer system 500.

In the example shown, computer system 500 includes various subsystems as described below. Computer system 500 includes at least one microprocessor subsystem (also referred to as a processor or a central processing unit (CPU)) 502. Computer system 500 can be physical or virtual (e.g., a virtual machine). For example, processor 502 can be implemented by a single-chip processor or by multiple processors. In some embodiments, processor 502 is a general-purpose digital processor that controls the operation of computer system 500. Using instructions retrieved from memory 510, processor 502 controls the reception and manipulation of input data, and the output and display of data on output devices (e.g., display 518).

Processor 502 is coupled bi-directionally with memory 510, which can include a first primary storage, typically a random-access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 502. Also, as is well known in the art, primary storage typically includes basic operating instructions, program code, data, and objects used by the processor 502 to perform its functions (e.g., programmed instructions). For example, memory 510 can include any suitable computer-readable storage media, described below, depending on whether, for example, data access needs to be bi-directional or uni-directional. For example, processor 502 can also directly and very rapidly retrieve and store frequently needed data in a cache memory (not shown).

Persistent memory 512 (e.g., a removable mass storage device) provides additional data storage capacity for computer system 500, and is coupled either bi-directionally (read/write) or uni-directionally (read only) to processor 502. For example, persistent memory 512 can also include computer-readable media such as magnetic tape, flash memory, PC-CARDS, portable mass storage devices, holographic storage devices, and other storage devices. A fixed mass storage 520 can also, for example, provide additional data storage capacity. The most common example of fixed mass storage 520 is a hard disk drive. Persistent memory 512 and fixed mass storage 520 generally store additional programming instructions, data, and the like that typically are not in active use by the processor 502. It will be appreciated that the information retained within persistent memory 512 and fixed mass storages 520 can be incorporated, if needed, in standard fashion as part of memory 510 (e.g., RAM) as virtual memory.

In addition to providing processor 502 access to storage subsystems, bus 514 can also be used to provide access to other subsystems and devices. As shown, these can include a display monitor 518, a network interface 516, a keyboard 504, and a pointing device 506, as well as an auxiliary input/output device interface, a sound card, speakers, and other subsystems as needed. For example, pointing device 506 can be a mouse, stylus, track ball, or tablet, and is useful for interacting with a graphical user interface.

Network interface 516 allows processor 502 to be coupled to another computer, computer network, or telecommunications network using a network connection as shown. For example, through network interface 516, processor 502 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 502 can be used to connect computer system 500 to an external network and transfer data according to standard protocols. Processes can be executed on processor 502, or can be performed across a network such as the Internet, intranet networks, or local area networks, in conjunction with a remote processor that shares a portion of the processing. Additional mass storage devices (not shown) can also be connected to processor 502 through network interface 516.

An auxiliary I/O device interface (not shown) can be used in conjunction with computer system 500. The auxiliary I/O device interface can include general and customized interfaces that allow processor 502 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 5 is but an example of a computer system suitable for use with the various embodiments disclosed herein. Other computer systems suitable for such use can include additional or fewer subsystems. In addition, bus 514 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving input data;
providing the received input data to a trained discriminative machine learning model to determine an inference result;
using at least a portion of the received input data to determine a utility measure; and
using a version of the determined inference result and the utility measure as inputs to a decision module optimizing one or more decision metrics to determine a decision result.

2. The method of claim 1, wherein the input data includes information associated with a transaction being analyzed for detection of fraud, money laundering, account takeover, inappropriate account opening, or other non-legitimate account activity behavior.

3. The method of claim 1, wherein the trained discriminative machine learning model is configured to perform a binary classification task.

4. The method of claim 1, wherein the trained discriminative machine learning model has been trained utilizing training data that includes information associated with a plurality of transactions, including, for each transaction of the plurality of transactions, a set of labeled transaction-related features and a labeled outcome as to whether fraudulent activity is present.

5. The method of claim 1, wherein the inference result is a probability estimate.

6. The method of claim 1, wherein the utility measure is associated with a rate at which the trained discriminative machine learning model correctly predicts a positive class associated with the received input data.

7. The method of claim 1, wherein the utility measure is associated with a monetary amount associated with the received input data.

8. The method of claim 1, wherein the version of the determined inference result includes a correction to a probability estimate.

9. The method of claim 8, wherein the correction to the probability estimate is associated with a disparity between a rate of occurrence of a data class in training data utilized to train the discriminative machine learning model and the rate of occurrence of the data class in data upon which the discriminative machine learning model operates after it is deployed.

10. The method of claim 8, wherein the correction to the probability estimate is associated with compensating for miscalibration of the trained discriminative machine learning model.

11. The method of claim 1, wherein the decision module includes a scoring function component that outputs a score based at least in part on the version of the determined inference result and the utility measure.

12. The method of claim 1, wherein the one or more decision metrics includes a constraint associated with one of the following: a false positive rate, an alert rate, or a precision metric that is based on true positive and false positive measures.

13. The method of claim 1, wherein the decision module optimizing the one or more decision metrics includes a component comparing a value based on the version of the determined inference result and the utility measure with a specified threshold.

14. The method of claim 13, wherein the specified threshold is adapted to a type of constraint associated with optimizing the one or more decision metrics.

15. The method of claim 1, wherein the one or more decision metrics include both a metric associated with correctly predicting a positive class associated with the received input data as well as a metric associated with a monetary amount associated with the received input data.

16. The method of claim 15, wherein the metric associated with correctly predicting the positive class and the metric associated with the monetary amount are formulated with respect to each other in terms of a parameterized scoring function.

17. The method of claim 1, wherein the decision module optimizing the one or more decision metrics includes a component maximizing a specified true positive rate of the trained discriminative machine learning model while maintaining a specified false positive rate of the trained discriminative machine learning model below a specified threshold.

18. The method of claim 1, wherein the decision result is a selection of one of two possible outcomes for the received input data.

19. A system, comprising:
one or more processors configured to:
receive input data;
provide the received input data to a trained discriminative machine learning model to determine an inference result;
use at least a portion of the received input data to determine a utility measure; and
use a version of the determined inference result and the utility measure as inputs to a decision module optimizing one or more decision metrics to determine a decision result; and
a memory coupled to at least one of the one or more processors and configured to provide at least one of the one or more processors with instructions.

20. A computer program product embodied in a non-transitory computer readable medium and comprising computer instructions for:
receiving input data;
providing the received input data to a trained discriminative machine learning model to determine an inference result;
using at least a portion of the received input data to determine a utility measure; and
using a version of the determined inference result and the utility measure as inputs to a decision module optimizing one or more decision metrics to determine a decision result.
